(19) United States
(12) Patent Application Publication
(10) Pub. No.: US 2026/0343433 A1
(43) Pub. Date: Oct. 29, 2026

(54) POWER CONTROL FOR BLUETOOTH LOW ENERGY COMMUNICATIONS

(71) Applicant: QUALCOMM Incorporated, San Diego, CA (US)

(72) Inventors: Yingchao XIE, Shanghai (CN); Jie ZENG, Shanghai (CN); Runyuan LIU, ShangHai (CN)

(21) Appl. No.: 19/118,312

(22) PCT Filed: Dec. 7, 2022
(86) PCT No.: PCT/CN2022/137109

§ 371 Date: Apr. 3, 2025

(51) Int. Cl. H04W 52/36; H04W 52/20; H04W 52/24; H04W 76/10

(52) U.S. Cl. CPC H04W 52/367; H04W 52/20; H04W 52/243; H04W 52/245; H04W 76/10

(57) ABSTRACT

This disclosure provides methods, components, devices, and systems for wireless communication. Some aspects more specifically relate to reducing the likelihood of a protocol data unit (PDU) being flushed during Bluetooth low energy (BLE) audio communications between wireless communication devices. According to some aspects of the subject matter described in this disclosure, a first wireless communication device may retransmit a PDU using a higher transmit power (such as a maximum transmit power of the first wireless communication device) in one or more sub-events leading up to a flush point of the PDU (for example, a final sub-event prior to the flush point) to increase the probability of a second wireless communication device successfully receiving the PDU before the PDU is flushed. The subject matter described in this disclosure may improve the quality and reliability of BLE audio communications between wireless communication devices, among other benefits.

### CROSS REFERENCE

This application is a 371 National Stage of PCT Application No. PCT/CN2022/137109, filed on Dec. 7, 2022, entitled “POWER CONTROL FOR BLUETOOTH LOW ENERGY COMMUNICATIONS”, and assigned to the assignee hereof. The disclosure of the prior Application is considered part of and is incorporated by reference into this Patent Application.

### TECHNICAL FIELD

This disclosure relates generally to wireless communication, and more specifically, to power control for Bluetooth low energy (BLE) communications.

### DESCRIPTION OF THE RELATED TECHNOLOGY

A wireless local area network (WLAN) may be formed by one or more wireless communication devices, such as access points (APs) that provide a shared wireless communication medium for use by multiple client devices, which may also be referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Some WLANs may support low energy communications between wireless communication devices. In some low energy communication schemes, packets that are not successfully received within a given time interval may be flushed (dropped), which may result in higher latency, decreased throughput, and greater signaling overhead.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a first wireless communication device. The method may include establishing a communication link with at least one second wireless communication device, where the communication link is associated with low energy audio communication between the first wireless communication device and the at least one second wireless communication device. The method may further include transmitting, to the at least one second wireless communication device via the communication link, one or more instances of a protocol data unit (PDU) using a first transmit power, where the PDU is associated with a flush point. The method may further include transmitting, to the at least one second wireless communication device via the communication link, at least one instance of the PDU using a second transmit power that is higher than the first transmit power, where the at least one instance of the PDU is transmitted during at least one sub-event that directly precedes the flush point associated with the PDU.

Another innovative aspect of the subject matter described in this disclosure can be implemented in an apparatus for wireless communication at a first wireless communication device. The apparatus includes a processor, memory coupled with the processor, and instructions stored in the memory. The instructions may be executable by the processor to cause the apparatus to establish a communication link with at least one second wireless communication device, where the communication link is associated with low energy audio communication between the first wireless communication device and the at least one second wireless communication device. The instructions may be further executable by the processor to cause the apparatus to transmit, to the at least one second wireless communication device via the communication link, one or more instances of a PDU using a first transmit power, where the PDU is associated with a flush point. The instructions may be further executable by the processor to cause the apparatus to transmit, to the at least one second wireless communication device via the communication link, at least one instance of the PDU using a second transmit power that is higher than the first transmit power, where the at least one instance of the PDU is transmitted during at least one sub-event that directly precedes the flush point associated with the PDU.

Another innovative aspect of the subject matter described in this disclosure can be implemented in an apparatus for wireless communication at a first wireless communication device. The apparatus may include means for establishing a communication link with at least one second wireless communication device, where the communication link is associated with low energy audio communication between the first wireless communication device and the at least one second wireless communication device. The apparatus may further include means for transmitting, to the at least one second wireless communication device via the communication link, one or more instances of a PDU using a first transmit power, where the PDU is associated with a flush point. The apparatus may further include means for transmitting, to the at least one second wireless communication device via the communication link, at least one instance of the PDU using a second transmit power that is higher than the first transmit power, where the at least one instance of the PDU is transmitted during at least one sub-event that directly precedes the flush point associated with the PDU.

Another innovative aspect of the subject matter described in this disclosure can be implemented in a non-transitory computer-readable medium storing code for wireless communication at a first wireless communication device. The code may include instructions executable by a processor to establish a communication link with at least one second wireless communication device, where the communication link is associated with low energy audio communication between the first wireless communication device and the at least one second wireless communication device. The instructions may be further executable by the processor to transmit, to the at least one second wireless communication device via the communication link, one or more instances of a PDU using a first transmit power, where the PDU is associated with a flush point. The instructions may be further executable by the processor to transmit, to the at least one second wireless communication device via the communication link, at least one instance of the PDU using a second transmit power that is higher than the first transmit power, where the at least one instance of the PDU is transmitted during at least one sub-event that directly precedes the flush point associated with the PDU.

Some innovative aspects of the subject matter described in this disclosure may further include increasing a transmit power of the first wireless communication device from the first transmit power to the second transmit power during the at least one sub-event based on failing to receive an acknowledgement (ACK) message associated with the one or more instances of the PDU transmitted using the first transmit power.

Some innovative aspects of the subject matter described in this disclosure may further include receiving, from the at least one second wireless communication device via the communication link, an ACK message associated with the at least one instance of the PDU transmitted using the second transmit power.

Some innovative aspects of the subject matter described in this disclosure may further include decreasing a transmit power of the first wireless communication device from the second transmit power to a third transmit power that is lower than the second transmit power in accordance with receiving the ACK message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless local area network (WLAN).

FIG. 2 shows an example protocol data unit (PDU) usable for communications between wireless communication devices.

FIG. 3 shows an example signaling diagram that supports power control for Bluetooth low energy (BLE) communications.

FIGS. 4A and 4B show example communication timelines that support power control for BLE communications.

FIGS. 5A and 5B show example communication timelines that support power control for BLE communications.

FIG. 6 shows an example process flow that supports power control for BLE communications.

FIGS. 7 and 8 show flowcharts illustrating example processes that support power control for BLE communications.

FIG. 9 shows a block diagram of an example wireless communication device that supports power control for BLE communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Some wireless communication networks may support Bluetooth Low Energy (BLE) communications between wireless communication devices. BLE may support relatively low power operations, and may be used across more than 40 channels in the 2.4 gigahertz (GHz) unlicensed industrial, scientific, and medial (ISM) frequency band. BLE can be used for various applications, such as device positioning, indoor location services, and audio streaming. In comparison to Bluetooth Classic audio schemes, such as Bluetooth Basic Rate (BR) and Enhanced Data Rate (EDR), BLE audio schemes can provide improved performance and greater power savings. BLE audio data may be communicated between wireless communication devices in the form of isochronous (ISO) packets, each of which may have an associated flush point. If, for example, an ISO packet (which may also be referred to as a protocol data unit (PDU)) is unsuccessfully received (due to noise or interference), a wireless communication device may retransmit the ISO packet until the flush point is reached, at which point the ISO packet may be flushed (dropped) from the audio stream. Flushed ISO packets can result in packet loss and noticeable audio glitches that adversely affect user experience.

To reduce the likelihood and/or frequency of ISO packet flushing in BLE audio communications, a wireless communication device can retransmit an ISO packet using a higher transmit power (such as a maximum transmit power of the wireless communication device) in one or more sub-events leading up to the flush point of the ISO packet (for example, a final sub-event prior to the flush point). For example, the wireless communication device may transmit the ISO packet using a first transmit power (for example, a baseline or default transmit power) during an initial set of one or more sub-events and, if an acknowledgement (ACK) for the ISO packet has yet to be received, the wireless communication device may transmit the ISO packet using a second, greater transmit power during a last one or more sub-events directly preceding the flush point of the ISO packet (where a quantity of the last one or more sub-events may be configurable or fixed). In some implementations, after using the higher transmit power to retransmit the ISO packet during the one or more sub-events directly preceding the flush point of the ISO packet, the wireless communication device may use a lower transmit power (for example, the first transmit power or another transmit power that is lower than the second transmit power) to transmit a subsequent ISO packet. In some other implementations, after using the higher transmit power to retransmit the ISO packet during the one or more sub-events directly preceding the flush point of the ISO packet, the wireless communication device may restart an evaluation timer and continue using the higher transmit power until the evaluation timer has expired. Thereafter, the wireless communication device may evaluate and/or adjust the transmit power based on factors such as a received signal strength indicator (RSSI) or a negative acknowledgement (NACK) rate.

Particular aspects of the subject matter described in this disclosure can be implemented to realize one or more of the following potential advantages. Using a higher transmit power to retransmit an ISO packet in one or more sub-events (also referred to as transmission opportunities or transmission occasions) leading up to a flush point of the ISO packet may improve the likelihood of the ISO packet being successfully received, thereby reducing the probability of the ISO packet being flushed. As such, the techniques described herein may result in fewer dropped (flushed) ISO packets, improved BLE audio quality, and better user experience (for example, less glitching). For example, reducing the frequency and/or likelihood of ISO packet flushing may enable wireless communication devices to transmit and receive BLE communications with reduced latency, greater communication reliability (for example, lower packet loss), and decreased signaling overhead. Further, the described techniques may enable wireless communication devices to adapt more quickly to dynamic, instantaneous, or otherwise fast-changing interference (for example, interference occurring in the middle of an evaluation interval). Thus, the described techniques may support relatively greater performance in relatively worse environments as compared to other techniques, which may further improve communication reliability.

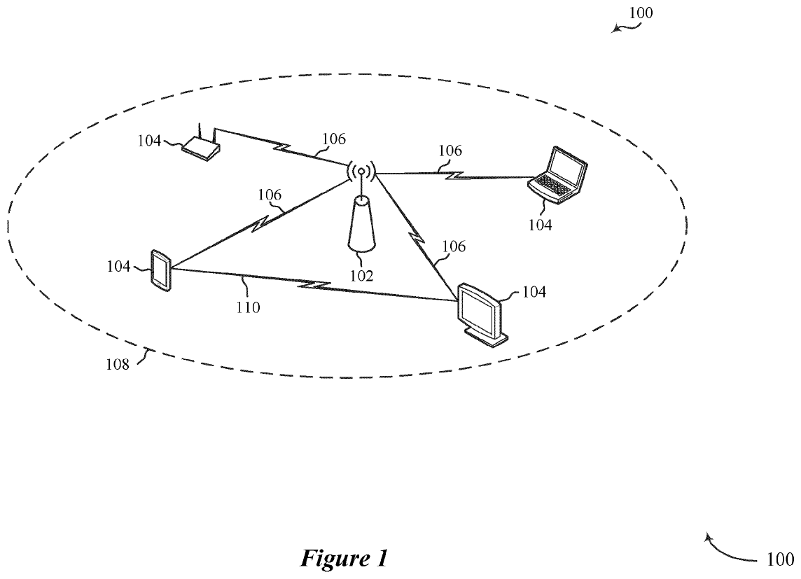

FIG. 1 shows a block diagram of an example WLAN 100. According to some aspects, the WLAN 100 can be an example of a Wi-Fi network. For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8).

The WLAN 100 may include numerous wireless communication devices such as a wireless access point (AP) 102 and multiple wireless stations (STAs) 104. While one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IOT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad-hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY PDUs (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a NACK that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In accordance with the example implementations described herein, a first wireless communication device (for example, a central device, which may be an AP 102 or a STA 104) may transmit a PDU to at least one second wireless communication device (for example, at least one peripheral device, which may be examples of connected devices or Bluetooth devices, such earbuds, headphones, a speaker, etc.) and may employ a variable transmit power technique to dynamically adjust a transmit power if a likelihood of the PDU being successfully received at the at least one second wireless communication device becomes lower (for example, becomes less than a threshold likeliness, which may be measured or assumed on a basis of a quantity of sub-events remaining until a flush point of the PDU). For example, the first wireless communication device may use a first transmit power for a first set of one or more instances of a PDU and may increase a transmit power from the first transmit power to a second transmit power if the first wireless communication device fails to receive an ACK from the second wireless communication device for the PDU prior to a last X sub-events that directly precede a flush point of the PDU. In examples in which the first wireless communication device fails to receive the ACK, the first wireless communication device may use the second transmit power to transmit one or more instances of the PDU during the X sub-events that directly precede the flush point of the PDU. As described herein, X may be any number including 1, 2, 3, and so on, and may be fixed or configurable.

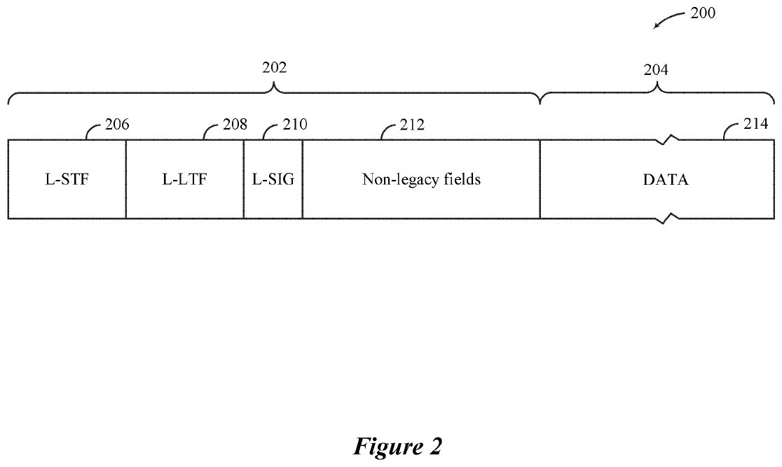

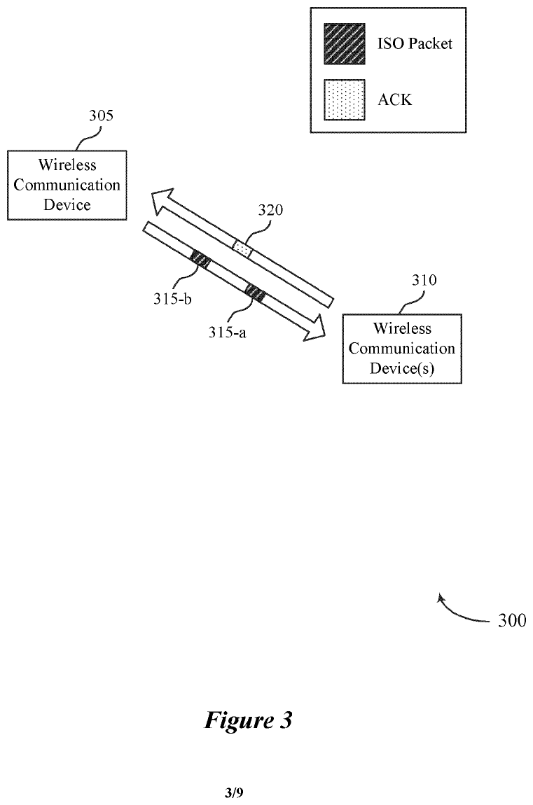

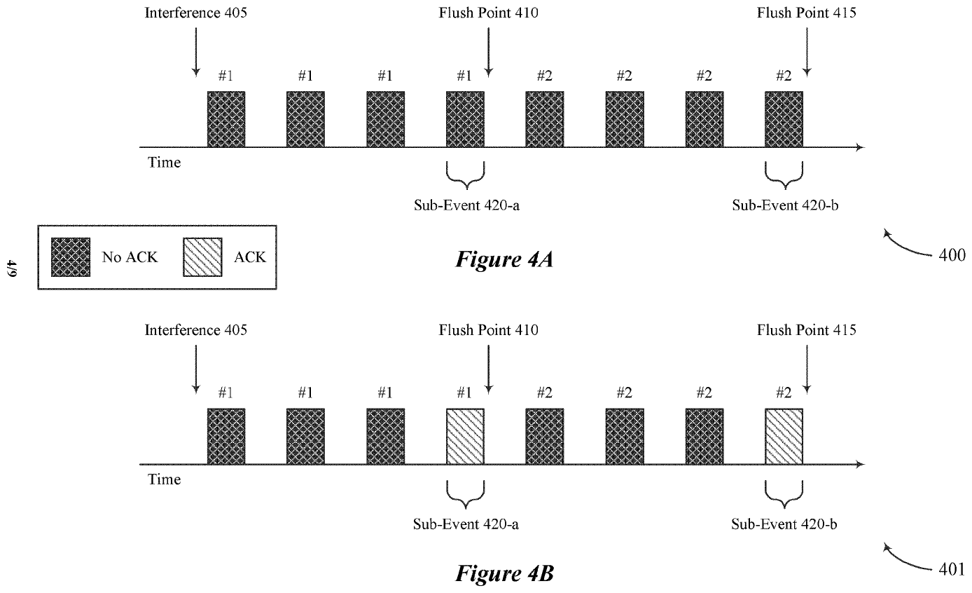

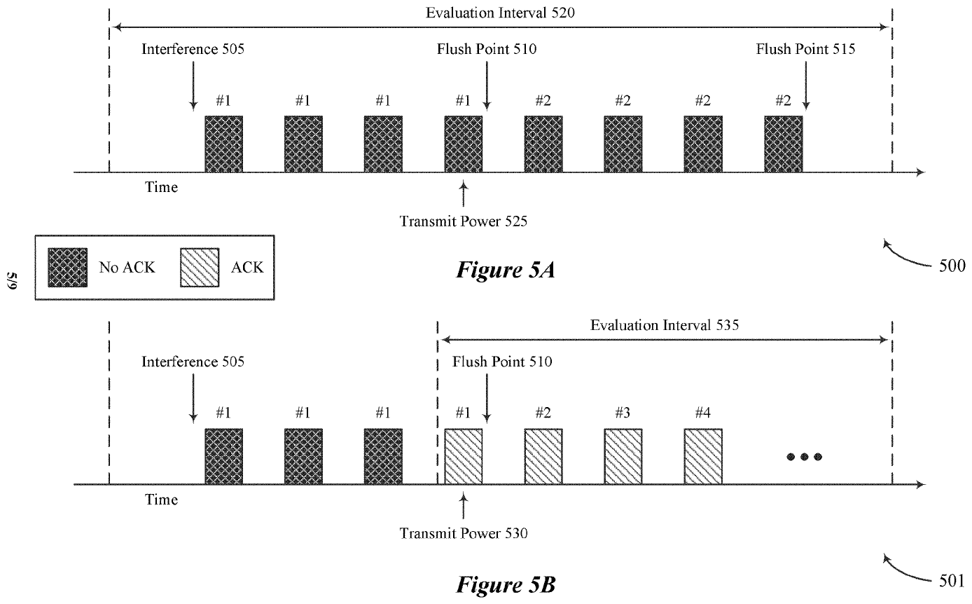

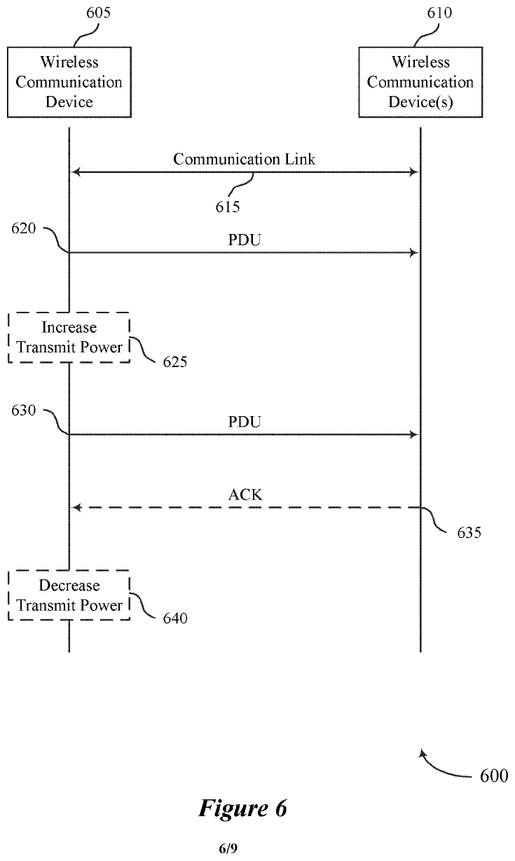

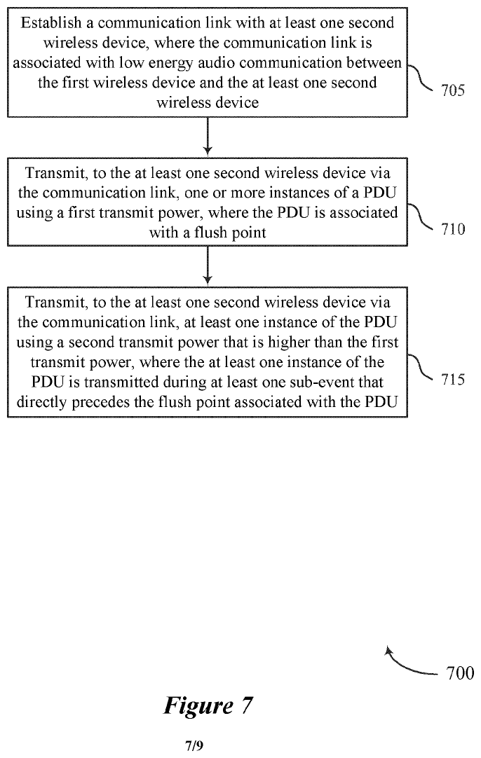

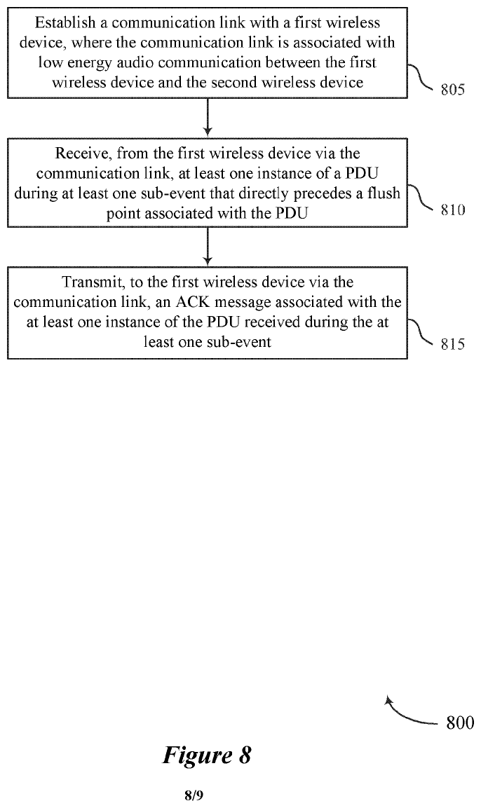

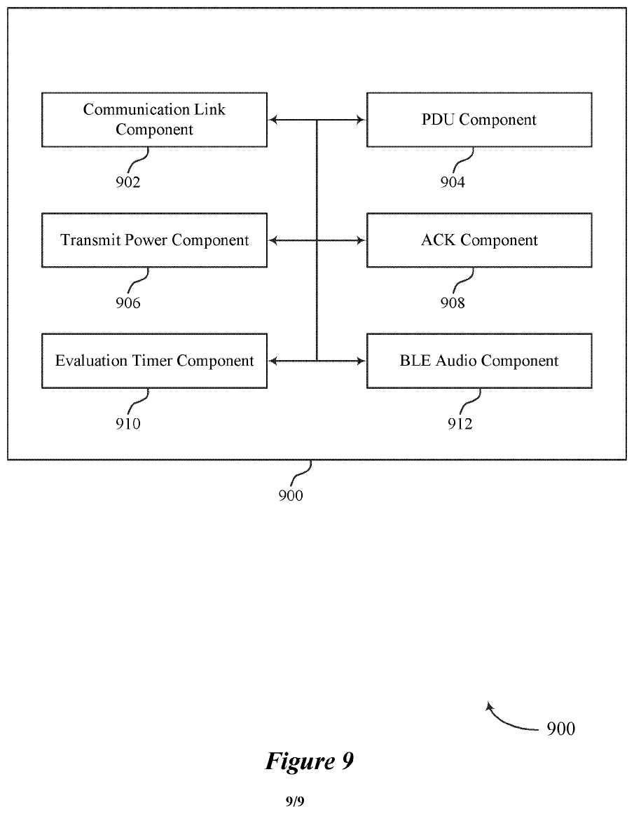

FIG. 2 shows an example PDU 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC PDUs (MPDUs) or an aggregated MPDU (A-MPDU).

In accordance with the example implementations described herein, a first wireless communication device (for example, a central device) may transmit a PDU 200 to at least one second wireless communication device (for example, at least one peripheral device) and may employ a variable transmit power technique to dynamically adjust a transmit power if a likelihood of the PDU 200 being successfully received at the at least one second wireless communication device becomes lower (for example, becomes less than a threshold likeliness, which may be measured or assumed on a basis of a quantity of sub-events remaining until a flush point of the PDU 200). For example, the first wireless communication device may use a first transmit power for a first set of one or more instances of a PDU 200 and may increase a transmit power from the first transmit power to a second transmit power if the first wireless communication device fails to receive an ACK from the second wireless communication device for the PDU 200 prior to a last X sub-events that directly precede a flush point of the PDU 200. In examples in which the first wireless communication device fails to receive the ACK, the first wireless communication device may use the second transmit power to transmit one or more instances of the PDU 200 during the X sub-events that directly precede the flush point of the PDU 200. As described herein, X may be any number including 1, 2, 3, and so on, and may be fixed or configurable.

In some examples, the wireless communication device 900 can be a device for use in a STA or an AP, such as a STA 104 or an AP 102 described with reference to FIG. 1. In some other examples, the wireless communication device 900 can be a STA or an AP that includes such a chip, SoC, chipset, package or device as well as multiple antennas. The wireless communication device 900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards.

In some examples, the wireless communication device 900 also includes or can be coupled with an application processor which may be further coupled with another memory. In some examples, the wireless communication device 900 further includes a user interface (UI) (such as a touchscreen or keypad) and a display, which may be integrated with the UI to form a touchscreen display. In some examples, the wireless communication device 900 may further include one or more sensors such as, for example, one or more inertial sensors, accelerometers, temperature sensors, pressure sensors, or altitude sensors.

The wireless communication device 900 includes a communication link component 902, a PDU component 904, a transmit power component 906, an ACK component 908, an evaluation timer component 910, and a BLE audio component 912. Portions of one or more of the components of the wireless communication device 900 may be implemented at least in part in hardware or firmware. For example, the PDU component 904 may be implemented at least in part by a modem. In some examples, at least some of the components 902, 904, 906, 908, 910, and 912 of the wireless communication device 900 are implemented at least in part by a processor and as software stored in a memory. For example, portions of one or more of the components 902, 904, 906, 908, 910, and 912 of the wireless communication device 900 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 900). For example, a processing system of the device 900 may refer to a system including the various other components or subcomponents of the device 900, such as the processor, or a transceiver, or a communications manager, or other components or combinations of components of the device 900. The processing system of the device 900 may interface with other components of the device 900, and may process information received from other components (such as inputs or signals) or output information to other components.

For example, a chip or modem of the device 900 may include a processing system, a first interface to output information and a second interface to obtain information. In some implementations, the first interface may refer to an interface between the processing system of the chip or modem and a transmitter, such that the device 900 may transmit information output from the chip or modem. In some implementations, the second interface may refer to an interface between the processing system of the chip or modem and a receiver, such that the device 900 may obtain information or signal inputs, and the information may be passed to the processing system. A person having ordinary skill in the art will readily recognize that the first interface also may obtain information or signal inputs, and the second interface also may output information or signal outputs.

The communication link component 902 may be capable of, configured to, or operable to establish a communication link with at least one second wireless communication device, where the communication link is associated with low energy audio communication between the wireless communication device 900 and the at least one second wireless communication device.

The PDU component 904 may be capable of, configured to, or operable to output, for transmission to the at least one second wireless communication device via the communication link, one or more instances of a PDU using a first transmit power, where the PDU is associated with a flush point.

The PDU component 904 may also be capable of, configured to, or operable to output, for transmission to the at least one second wireless communication device via the communication link, at least one instance of the PDU using a second transmit power that is higher than the first transmit power, where the at least one instance of the PDU is transmitted during at least one sub-event that directly precedes the flush point associated with the PDU. In some examples, the at least one sub-event includes a single last sub-event before the flush point associated with the PDU. In some other examples, the at least one sub-event is a part of a CIS event within an ISO interval.

The transmit power component 906 may be capable of, configured to, or operable to increase a transmit power of the wireless communication device 900 from the first transmit power to the second transmit power during the at least one sub-event based on failing to receive an ACK message associated with the one or more instances of the PDU transmitted using the first transmit power.

The ACK component 908 may be capable of, configured to, or operable to receive, from the at least one second wireless communication device via the communication link, an ACK message associated with the at least one instance of the PDU transmitted using the second transmit power. In some examples, the second transmit power corresponds to a maximum transmit power of the wireless communication device 900.

In some examples, the transmit power component 906 may be capable of, configured to, or operable to decrease a transmit power of the wireless communication device 900 from the second transmit power to a third transmit power that is lower than the second transmit power in accordance with receiving the ACK message. In some examples, the transmit power component 906 may decrease the transmit power of the wireless communication device 900 from the second transmit power to the third transmit power after a quantity of ISO intervals have elapsed with respect to reception of the ACK message associated with the at least one instance of the PDU.

In some examples, the transmit power component 906 may be capable of, configured to, or operable to increase a transmit power of the wireless communication device 900 from the first transmit power to the second transmit power during the at least one sub-event based on an instantaneous interference level associated with the communication link between the wireless communication device 900 and the at least one second wireless communication device.

The evaluation timer component 910 may be capable of, configured to, or operable to restart a timer associated with an evaluation interval in accordance with increasing a transmit power of the wireless communication device 900 from the first transmit power to the second transmit power, where the wireless communication device 900 communicates in accordance with multiple evaluation intervals including the evaluation interval, and where each evaluation interval of the multiple evaluation intervals is associated with a respective baseline transmit power that is adjusted with respect to a respective previous evaluation interval.

In some examples, the wireless communication device 900 may be capable of, configured to, or operable to use the second transmit power to communicate with the at least one second wireless communication device until the timer associated with the evaluation interval has expired.

In some examples, the PDU component 904 may be capable of, configured to, or operable to output, for transmission to the at least one second wireless communication device via the communication link, a second PDU using the second transmit power in accordance with increasing a transmit power of the wireless communication device 900 from the first transmit power to the second transmit power during the at least one sub-event, where the second PDU is transmitted during one or more sub-events after the at least one sub-event.

In some examples, the transmit power component 906 may be capable of, configured to, or operable to increase a transmit power of the wireless communication device 900 during an evaluation interval that includes the at least one sub-event, where the wireless communication device 900 communicates during multiple evaluation intervals including the evaluation interval, and where each evaluation interval of the multiple evaluation intervals is associated with a respective baseline transmit power that is adjusted with respect to a respective previous evaluation interval, and where a baseline transmit power of the evaluation interval is the first transmit power.

In some examples, the transmit power component 906 may be capable of, configured to, or operable to adjust a transmit power of the wireless communication device 900 after the evaluation interval based on a NACK rate associated with communications between the wireless communication device 900 and the at least one second wireless communication device, an RSSI associated with the communications between the wireless communication device 900 and the at least one second wireless communication device, or both.

The BLE audio component 912 may be capable of, configured to, or operable to include BLE audio data in an ISO PDU that is communicated to the at least one second wireless communication device in accordance with a CIS between the wireless communication device 900 and the at least one second wireless communication device.

Implementation examples are described in the following numbered clauses:

Clause 1: A method for wireless communication at a first wireless communication device, including: establishing a communication link with at least one second wireless communication device, where the communication link is associated with low energy audio communication between the first wireless communication device and the at least one second wireless communication device; transmitting, to the at least one second wireless communication device via the communication link, one or more instances of a PDU using a first transmit power, where the PDU is associated with a flush point; and transmitting, to the at least one second wireless communication device via the communication link, at least one instance of the PDU using a second transmit power that is higher than the first transmit power, where the at least one instance of the PDU is transmitted during at least one sub-event that directly precedes the flush point associated with the PDU.

Clause 2: The method of clause 1, further including: increasing a transmit power of the first wireless communication device from the first transmit power to the second transmit power during the at least one sub-event based at least in part on failing to receive an ACK message associated with the one or more instances of the PDU transmitted using the first transmit power.

Clause 3: The method of any of clauses 1 through 2, further including: receiving, from the at least one second wireless communication device via the communication link, an ACK message associated with the at least one instance of the PDU transmitted using the second transmit power; and decreasing a transmit power of the first wireless communication device from the second transmit power to a third transmit power that is lower than the second transmit power in accordance with receiving the ACK message.

Clause 4: The method of clause 3, where decreasing the transmit power includes: decreasing the transmit power of the first wireless communication device from the second transmit power to the third transmit power after a quantity of ISO intervals have elapsed with respect to reception of the ACK message associated with the at least one instance of the PDU.

Clause 5: The method of any of clauses 1 through 4, further including: increasing a transmit power of the first wireless communication device from the first transmit power to the second transmit power during the at least one sub-event based at least in part on an instantaneous interference level associated with the communication link between the first wireless communication device and the at least one second wireless communication device.

Clause 6: The method of any of clauses 1 through 5, further including: restarting a timer associated with an evaluation interval in accordance with increasing a transmit power of the first wireless communication device from the first transmit power to the second transmit power, where the first wireless communication device communicates during a plurality of evaluation intervals including the evaluation interval, and where each evaluation interval of the plurality of evaluation intervals is associated with a respective baseline transmit power that is adjusted with respect to a respective previous evaluation interval; and using the second transmit power to communicate with the at least one second wireless communication device until the timer associated with the evaluation interval has expired.

Clause 7: The method of any of clauses 1 through 6, further including: transmitting, to the at least one second wireless communication device via the communication link, a second PDU using the second transmit power in accordance with increasing a transmit power of the first wireless communication device from the first transmit power to the second transmit power during the at least one sub-event, where the second PDU is transmitted during one or more sub-events after the at least one sub-event.

Clause 8: The method of any of clauses 1 through 7, further including: increasing a transmit power of the first wireless communication device during an evaluation interval that includes the at least one sub-event, where the first wireless communication device communicates during a plurality of evaluation intervals including the evaluation interval, and where each evaluation interval of the plurality of evaluation intervals is associated with a respective baseline transmit power that is adjusted with respect to a respective previous evaluation interval, and where a baseline transmit power of the evaluation interval is the first transmit power.

Clause 9: The method of clause 8, further including: adjusting a transmit power of the first wireless communication device after the evaluation interval based at least in part on a NACK rate associated with communications between the first wireless communication device and the at least one second wireless communication device, an RSSI associated with the communications between the first wireless communication device and the at least one second wireless communication device, or both.

Clause 10: The method of any of clauses 1 through 9, where the at least one sub-event includes a single last sub-event before the flush point associated with the PDU.

Clause 11: The method of any of clauses 1 through 10, where the second transmit power corresponds to a maximum transmit power of the first wireless communication device.

Clause 12: The method of any of clauses 1 through 11, where the PDU includes an ISO PDU that includes BLE audio data.

Clause 13: The method of any of clauses 1 through 12, where the at least one sub-event is a part of a CIS event within an ISO interval.

Clause 14: An apparatus for wireless communication at a first wireless communication device, including: a processor; memory coupled with the processor; and instructions stored in the memory and executable by the processor to cause the apparatus to perform a method of any of clauses 1 through 13.

Clause 15: An apparatus for wireless communication at a first wireless communication device, including: at least one means for performing a method of any of clauses 1 through 13.

Clause 16: A non-transitory computer-readable medium storing code for wireless communication at a first wireless communication device, the code including instructions executable by a processor to perform a method of any of clauses 1 through 13.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication at a first wireless communication device, comprising:
a processor;
memory coupled with the processor; and
instructions stored in the memory and executable by the processor to cause the apparatus to:
establish a communication link with at least one second wireless communication device, wherein the communication link is associated with low energy audio communication between the first wireless communication device and the at least one second wireless communication device;
transmit, to the at least one second wireless communication device via the communication link, one or more instances of a protocol data unit using a first transmit power, wherein the protocol data unit is associated with a flush point; and
transmit, to the at least one second wireless communication device via the communication link, at least one instance of the protocol data unit using a second transmit power that is higher than the first transmit power, wherein the at least one instance of the protocol data unit is transmitted during at least one sub-event that directly precedes the flush point associated with the protocol data unit.

2. The apparatus of claim 1, wherein the instructions are further executable by the processor to cause the apparatus to:
increase a transmit power of the first wireless communication device from the first transmit power to the second transmit power during the at least one sub-event based at least in part on failing to receive an acknowledgement message associated with the one or more instances of the protocol data unit transmitted using the first transmit power.

3. The apparatus of claim 1, wherein the instructions are further executable by the processor to cause the apparatus to:
receive, from the at least one second wireless communication device via the communication link, an acknowledgement message associated with the at least one instance of the protocol data unit transmitted using the second transmit power; and
decrease a transmit power of the first wireless communication device from the second transmit power to a third transmit power that is lower than the second transmit power in accordance with receiving the acknowledgement message.

4. The apparatus of claim 3, wherein, to decrease the transmit power, the instructions are executable by the processor to cause the apparatus to:
decrease the transmit power of the first wireless communication device from the second transmit power to the third transmit power after a quantity of isochronous (ISO) intervals have elapsed with respect to reception of the acknowledgement message associated with the at least one instance of the protocol data unit.

5. The apparatus of claim 1, wherein the instructions are further executable by the processor to cause the apparatus to:
increase a transmit power of the first wireless communication device from the first transmit power to the second transmit power during the at least one sub-event based at least in part on an instantaneous interference level associated with the communication link between the first wireless communication device and the at least one second wireless communication device.

6. The apparatus of claim 1, wherein the instructions are further executable by the processor to cause the apparatus to:
restart a timer associated with an evaluation interval in accordance with increasing a transmit power of the first wireless communication device from the first transmit power to the second transmit power, wherein the first wireless communication device communicates during a plurality of evaluation intervals including the evaluation interval, and wherein each evaluation interval of the plurality of evaluation intervals is associated with a respective baseline transmit power that is adjusted with respect to a respective previous evaluation interval; and
use the second transmit power to communicate with the at least one second wireless communication device until the timer associated with the evaluation interval has expired.

7. The apparatus of claim 1, wherein the instructions are further executable by the processor to cause the apparatus to:
transmit, to the at least one second wireless communication device via the communication link, a second protocol data unit using the second transmit power in accordance with increasing a transmit power of the first wireless communication device from the first transmit power to the second transmit power during the at least one sub-event, wherein the second protocol data unit is transmitted during one or more sub-events after the at least one sub-event.

8. The apparatus of claim 1, wherein the instructions are further executable by the processor to cause the apparatus to:
increase a transmit power of the first wireless communication device during an evaluation interval that includes the at least one sub-event, wherein the first wireless communication device communicates during a plurality of evaluation intervals including the evaluation interval, and wherein each evaluation interval of the plurality of evaluation intervals is associated with a respective baseline transmit power that is adjusted with respect to a respective previous evaluation interval, and wherein a baseline transmit power of the evaluation interval is the first transmit power.

9. The apparatus of claim 8, wherein the instructions are further executable by the processor to cause the apparatus to:
adjust a transmit power of the first wireless communication device after the evaluation interval based at least in part on a negative acknowledgement (NACK) rate associated with communications between the first wireless communication device and the at least one second wireless communication device, a received signal strength indicator (RSSI) associated with the communications between the first wireless communication device and the at least one second wireless communication device, or both.

10. The apparatus of claim 1, wherein the at least one sub-event includes a single last sub-event before the flush point associated with the protocol data unit.

11. The apparatus of claim 1, wherein the second transmit power corresponds to a highest transmit power of the first wireless communication device.

12. The apparatus of claim 1, wherein the protocol data unit comprises an isochronous (ISO) protocol data unit that includes Bluetooth Low Energy (BLE) audio data.

13. The apparatus of claim 1, wherein the at least one sub-event is a part of a connected isochronous stream (CIS) event within an isochronous (ISO) interval.

14. A method for wireless communication at a first wireless communication device, comprising:
establishing a communication link with at least one second wireless communication device, wherein the communication link is associated with low energy audio communication between the first wireless communication device and the at least one second wireless communication device; transmitting, to the at least one second wireless communication device via the communication link, one or more instances of a protocol data unit using a first transmit power, wherein the protocol data unit is associated with a flush point; and
transmitting, to the at least one second wireless communication device via the communication link, at least one instance of the protocol data unit using a second transmit power that is higher than the first transmit power, wherein the at least one instance of the protocol data unit is transmitted during at least one sub-event that directly precedes the flush point associated with the protocol data unit.

15. The method of claim 14, further comprising:
increasing a transmit power of the first wireless communication device from the first transmit power to the second transmit power during the at least one sub-event based at least in part on failing to receive an acknowledgement message associated with the one or more instances of the protocol data unit transmitted using the first transmit power.

16. The method of claim 14, further comprising:
receiving, from the at least one second wireless communication device via the communication link, an acknowledgement message associated with the at least one instance of the protocol data unit transmitted using the second transmit power; and
decreasing a transmit power of the first wireless communication device from the second transmit power to a third transmit power that is lower than the second transmit power in accordance with receiving the acknowledgement message.

17. The method of claim 16, wherein decreasing the transmit power comprises:
decreasing the transmit power of the first wireless communication device from the second transmit power to the third transmit power after a quantity of isochronous (ISO) intervals have elapsed with respect to reception of the acknowledgement message associated with the at least one instance of the protocol data unit.

18. The method of claim 14, further comprising:
increasing a transmit power of the first wireless communication device from the first transmit power to the second transmit power during the at least one sub-event based at least in part on an instantaneous interference level associated with the communication link between the first wireless communication device and the at least one second wireless communication device.

19. The method of claim 14, further comprising:
restarting a timer associated with an evaluation interval in accordance with increasing a transmit power of the first wireless communication device from the first transmit power to the second transmit power, wherein the first wireless communication device communicates during a plurality of evaluation intervals including the evaluation interval, and wherein each evaluation interval of the plurality of evaluation intervals is associated with a respective baseline transmit power that is adjusted with respect to a respective previous evaluation interval; and
using the second transmit power to communicate with the at least one second wireless communication device until the timer associated with the evaluation interval has expired.

20-26. (canceled)

27. An apparatus for wireless communication at a first wireless communication device, comprising:
means for establishing a communication link with at least one second wireless communication device, wherein the communication link is associated with low energy audio communication between the first wireless communication device and the at least one second wireless communication device;
means for transmitting, to the at least one second wireless communication device via the communication link, one or more instances of a protocol data unit using a first transmit power, wherein the protocol data unit is associated with a flush point; and
means for transmitting, to the at least one second wireless communication device via the communication link, at least one instance of the protocol data unit using a second transmit power that is higher than the first transmit power, wherein the at least one instance of the protocol data unit is transmitted during at least one sub-event that directly precedes the flush point associated with the protocol data unit.

28-30. (canceled)
